(19) United States
(12) Patent Application Publication
(10) Pub. No.: US 2020/0353660 A1
(43) Pub. Date: Nov. 12, 2020

(54) INJECTION MOLD AND MANUFACTURING METHOD FOR THE SAME

(71) Applicant: SAMSUNG ELECTRONICS CO., LTD., Gyeonggi-do (KR)

(72) Inventor: Woo Jin LEE, Suwon-si (KR)

(73) Assignee: SAMSUNG ELECTRONICS CO., LTD., Suwon-si, Gyeonggi-do (KR)

(21) Appl. No.: 16/761,102

(22) PCT Filed: Sep. 3, 2018
(86) PCT No.: PCT/KR2018/010228

§ 371 Date: May 1, 2020

(30) Foreign Application Priority Data
Nov. 1, 2017 (KR) 10-2017-0144515

(51) Int. Cl. B29C 45/73

(52) U.S. Cl. CPC B29C 45/7312; B29C 45/2602

(57) ABSTRACT

Provided are an injection mold including a cooling channel through which a cooling fluid flows, and a method of manufacturing the same. The injection mold includes: a core comprising a first core configured to form a cavity corresponding to a shape of an injection object and a second core separably coupled to the first core; and a cooling channel communicating with an outside of the core and comprising a first cooling channel horizontally provided in the core to guide flow of a cooling fluid for cooling the core and a second cooling channel vertically provided in the core while crossing the first cooling channel, wherein the second cooling channel includes: a sub-cooling channel communicating with the first cooling channel; and a main cooling channel overlapping the sub-cooling channel.

### TECHNICAL FIELD

The disclosure relates to an injection mold including a cooling channel through which a cooling fluid flows, and a method of manufacturing the same.

### BACKGROUND ART

In general, a mold includes an injection mold for producing a plastic product, a press mold for producing a product using an iron plate, a die casting mold for producing a product like a plastic by melting a metal, and the mold is divided into a moving mold and a fixed mold that are separately fabricated for smooth production of products.

Here, the injection mold is a device for manufacturing an injection object by injecting a molten resin into a cavity provided in the injection mold and hardening the molten resin therein. The injection mold is connected to an injection device for injecting a molten resin into the cavity and a cooling device for supplying a cooling fluid.

The injection mold includes a pair of cores each including a mold surface having a shape corresponding to one surface of an injection object to be manufactured, and combined with each other to form a cavity corresponding to the injection object to be manufactured.

A plastic injection process by injection mold may include a raw material feeding process, a drying process, an injection molding machine material feeding process, an injection molding, a product ejection process, a product post-processing, and a packaging process.

Here, the injection molding process may include an injection process for filling a molten resin into an injection mold, followed by a cooling process for hardening the resin.

The cooling process of the injection mold may be performed by piping a cooling channel inside the core of the injection mold for shaping a product, and allowing an injection object to be cooled and hardened by a cooling fluid passing through the cooling channel.

In general, a cooling method used in a cooling process employs a baffle method disposing a baffle plate, which is a part that facilitates circulation of a cooling fluid, inside the injection mold to make heat conduction of the injection mold uniform and to improve the shape of the product.

However, even with a cooling channel employing a baffle plate, one side and the other side of the core may be unevenly cooled depending on the shape of the injection object, which may cause deformation of the product and delay of the cooling time for the entire injection mold, increasing the ejection cycle of the product, and eventually decreasing the productivity of the injection object.

### DISCLOSURE

### Technical Problem

Therefore, it is an object of the disclosure to provide an injection mold with an improved cooling channel through which a cooling fluid for cooling the injection mold flows, and a method of manufacturing the same.

It is another object of the disclosure to provide an injection mold that is improved such that a cooling channel following a vertical cooling line is disposed adjacent to an injection object while depending on a cooling channel following a horizontal cooling line, and a method of manufacturing the same.

### Technical Solution

According to an aspect of the present invention, there is provided an injection mold including: a core comprising a first core configured to form a cavity corresponding to a shape of an injection object and a second core separably coupled to the first core; and a cooling channel communicating with an outside of the core and comprising a first cooling channel horizontally provided in the core to guide flow of a cooling fluid for cooling the core and a second cooling channel vertically provided in the core while crossing the first cooling channel, wherein the second cooling channel includes: a sub-cooling channel communicating with the first cooling channel; and a main cooling channel overlapping the sub-cooling channel.

The first cooling channel may be provided in a plurality of units thereof to be spaced apart from each other, the main cooling channel may be disposed to be spaced apart from two adjacent first cooling channels of the plurality of first cooling channels.

The cooling channel may be configured to direct the cooling fluid in the cooling channel in a first direction flowing along the first cooling channel, a second direction flowing along the second cooling channel, and a third direction flowing between the sub-cooling channel and the main cooling channel.

The main cooling channel may be spaced apart from the first cooling channel in the third direction.

The sub-cooling channel and the main cooling channel may have different lengths in the second direction.

The injection mold may further include a baffle plate configured to guide the cooling fluid flowing through the second cooling channel, and including a sub-baffle portion inserted into the sub-cooling channel and a main baffle portion inserted into the main cooling channel.

The injection mold may further include a cap inserted into the second cooling channel and coupled to one end portion of the baffle plate to prevent the cooling fluid flowing through the second cooling channel from being discharged out of the core, wherein the cap may include a sub-cap portion corresponding to a shape of the sub-cooling channel and a main cap portion corresponding to a shape of the main-cooling channel.

The cap may include a cap groove into which the baffle plate is inserted and a cap ring groove into which a cap ring for sealing between the second cooling channel and the cap is inserted.

The cap may include: a press ring groove arranged below the cap ring groove and into which a press ring for pressing the cap is inserted; and a screw groove into which a taper screw interacting with the press ring to press the cap is inserted and provided in a lower portion of the cap.

The main cooling channel may be arranged closer to a portion of an injection object disposed between the two adjacent first cooling channels of the plurality of first cooling channels than the sub-cooling channel may be.

The main cooling channel may be arranged closer to an injection port for injecting a resin for forming the injection object into the cavity than the sub-cooling channel may be.

The injection mold may further include a mold plate accommodating the core to prevent the cooling fluid flowing through the second cooling channel from being discharged out of the core, wherein the mold plate may include a sub-mold plate portion for blocking the sub-cooling channel and a main mold plate portion for blocking the main cooling channel.

The mold plate may include a mold plate groove into which the baffle plate is inserted and an O-ring groove into which an O-ring for sealing between the core and the mold plate is inserted.

The cooling channel may be configured such that the cooling fluid introduced through an inlet provided in the core flows through the first cooling channel along the first direction, is switched along the third direction from flowing through the sub-cooling channel to flowing through the main cooling channel, and is switched along the second direction to flowing through the second cooling channel.

According to another aspect of the present invention, there is provided a method of manufacturing an injection mold, the method including: forming a first cooling channel horizontally to pass through a core such that the first cooling channel allows a cooling fluid for cooling the core to flow therethough and has a first end portion of the core and a second end portion opposite to the first end portion communicate with each other; forming a sub-cooling channel vertically to pass through the core while crossing the first cooling channel and communicating with a third end portion of the core; and forming a main-cooling channel vertically to pass through the core while communicating with the third end portion of the core and overlapping the sub-cooing channel.

### Advantageous Effects

As is apparent from the above, the disclosure improves the cooling channel through which a cooling fluid for cooling an injection mold flows, so that the cooling efficiency can be improved and the quality and productivity of the injection object can be improved. The disclosure allows a cooling channel following a vertical cooling line to be disposed adjacent to an injection object while depending on a cooling channel following a horizontal cooling line, so that the core can be uniformly cooled.

The disclosure can improve the degree of freedom of the arrangement of the vertical cooling channel even when a cooling channel following a vertical cooling line depends on a cooling channel following a horizontal cooling line.

### DESCRIPTION OF DRAWINGS

FIG. 1 is a perspective view illustrating an injection mold according to the disclosure.

FIG. 2 is a cross-sectional view illustrating an injection mold according to the disclosure, which is viewed along line A-A′ in FIG. 1.

FIG. 3 is a view illustrating an injection mold according to the disclosure, which shows a cooling channel disposed inside a second core.

FIG. 4 is a view illustrating an injection mold according to the disclosure, which shows a flow of a cooling fluid flowing in a cooling channel.

FIG. 5 is an exploded view illustrating an injection mold according to the disclosure, which shows disassembled parts of a cooling channel.

FIG. 6 is a cross-sectional view illustrating an injection mold according to the disclosure, which is viewed along line B-B′ in FIG. 1.

FIG. 7 is a view illustrating an injection mold according to the disclosure, in which a main cooling channel is disposed adjacent to a part of an injection object.

FIG. 8 is a view illustrating an injection mold according to the disclosure, which shows a main cooling channel disposed adjacent to an injection port.

FIG. 9 is a perspective view illustrating an injection mold according to another embodiment of the disclosure.

FIG. 10 is a cross-sectional view illustrating an injection mold according to another embodiment of the disclosure, which is viewed along line A-A′ in FIG. 9.

FIG. 11 is an exploded view illustrating an injection mold according to another embodiment of the disclosure, in which a core including a cooling channel and a template are disassembled.

### BEST MODES OF THE DISCLOSURE

### Modes of the Disclosure

The embodiments set forth herein and illustrated in the configuration of the present disclosure are only the most preferred embodiments and are not representative of the full the technical spirit of the present disclosure, so it should be understood that they may be replaced with various equivalents and modifications at the time of the disclosure.

Throughout the drawings, like reference numerals refer to like parts or components.

The terminology used herein is for the purpose of describing particular embodiments only and is not intended to limit the disclosure. It is to be understood that the singular forms “a,” “an,” and “the” include plural references unless the context clearly dictates otherwise.

It will be further understood that the terms “include”, “comprise” and/or “have” when used in this specification, specify the presence of stated features, integers, steps, operations, elements, and/or components, but do not preclude the presence or addition of one or more other features, integers, steps, operations, elements, components, and/or groups thereof.

The terms including ordinal numbers like “first” and “second” may be used to explain various components, but the components are not limited by the terms. The terms are only for the purpose of distinguishing a component from another.

Thus, a first element, component, region, layer or section discussed below could be termed a second element, component, region, layer or section without departing from the teachings of the disclosure. Descriptions shall be understood as to include any and all combinations of one or more of the associated listed items when the items are described by using the conjunctive term “˜and/or˜,” or the like.

The terms “front”, “rear”, “upper”, “lower”, “top”, and “bottom” as herein used are defined with respect to the drawings, but the terms may not restrict the shape and position of the respective components.

Hereinafter, embodiments according to the disclosure will be described in detail with reference to the accompanying drawings.

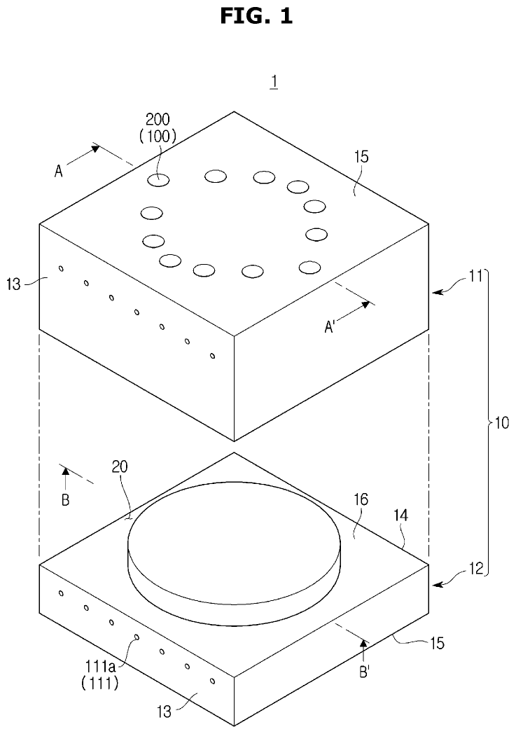

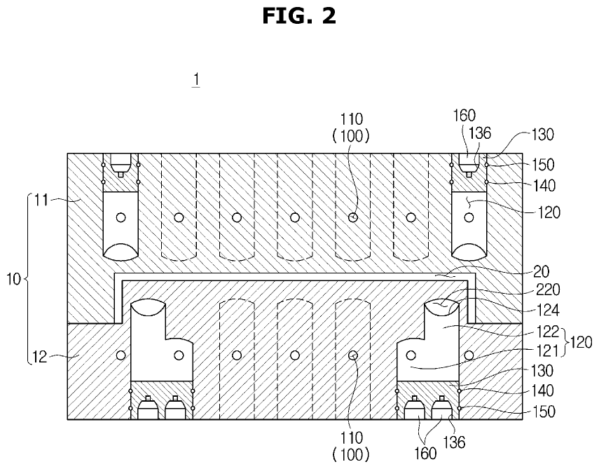

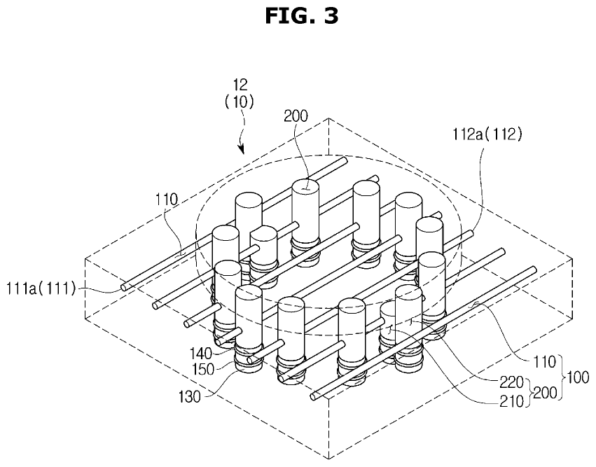

FIG. 1 is a perspective view illustrating an injection mold according to the disclosure. FIG. 2 is a cross-sectional view illustrating an injection mold according to the disclosure, which is viewed along line A-A′ in FIG. 1. FIG. 3 is a view illustrating an injection mold according to the disclosure, which shows a cooling channel disposed inside a second core.

Referring to FIGS. 1 to 3, an injection mold 1 according to the disclosure may include a core 10 configured to injection-mold an injection object. The core 10 may include a first core 11 and a second core 12 forming a cavity 20 corresponding to the shape of the injection object to be manufactured together with the first core 11.

The injection mold 1 may include a mold for injection molding a back panel of a television. However, the disclosure is not limited there, and the injection mold 1 according to the disclosure may be applied to all injection objects molded using plastic resins.

In addition, although not shown in the drawings, the injection mold 1 according to the disclosure may further include other configurations, such as a cooling device (not shown) for supplying a cooling fluid to the injection mold 1 and a transfer device (not shown) for moving at least one of the first core 11 and the second core 12.

In this embodiment, the second core 12 may be fixedly installed on the ground, and the first core 11 may be installed to be movable up and down on the second core 12. Therefore, when the first core 11 moves downward to be coupled to the second core 12, the cavity 20 may be formed, and when the first core 11 moves upward to be separated from the second core 12, the injection object manufactured in the cavity 20 may be taken out from the injection mold 1.

In this embodiment, the first core 11 and the second core 12 may be arranged one above the other, but this is for illustrative purpose only, and the first core 11 and the second core 12 may be arranged side by side on the left and right sides.

In addition, the second core 12 may be movable instead of the first core 11, or both the first core 11 and the second core 12 may be movably provided.

The core 10 may include a first end portion 13 forming one side of the core 10, and a second end portion 14 provided opposite to the first end portion 13 and forming the other side of the core 10.

The core 10 may include a third end portion 15 forming an outer side of the core 10 and a fourth end portion 16 provided opposite to the third end portion 15 and forming an inner side of the core 10.

The first core 11 and the second core 12 may include a mold surface having a shape corresponding to one surface of an injection object to be manufactured. In this embodiment, the mold surface provided on the core 10 may be configured to manufacture an injection object having a flat surface.

However, the disclosure is not limited thereto, and the mold surface provided on the core 10 may include a curved surface portion formed as a curved surface to manufacture an injection object having a curved surface.

The first core 11 may include a mold surface having a shape corresponding to that of a first surface of an injection object to be manufactured, and the second core 12 may include a mold surface having a shape corresponding to that of a second surface of the injection object positioned at a side opposite to the first surface. The mold surfaces of the core 10 may be provided on the fourth end portion 16.

During injection molding, when a resin is injected into the cavity 20, the temperature of the core 10 increases due to the high temperature of the resin, and thus a cooling process for cooling the elevated temperature is required.

Therefore, the core 10 may be cooled by receiving a cooling fluid such as water through a cooling device (not shown), and in this manner, the hardening speed of the molten resin injected into the cavity 20 may be adjusted.

The first core 11 and the second core 12 may be each provided with a cooling channel 100 through which the cooling fluid supplied from a cooling device (not shown) passes. The cooling channel 100 may be formed to be spaced apart from the mold surface of the core 10 by a predetermined distance. This is to allow the molten resin filled in the cavity 20 to be evenly cooled.

The cooling channel 100 may be provided in a plurality of units thereof. The cooling channel 100 may be disposed inside the core 10 to correspond to the shape of the injection object in order to cool the core 10 evenly.

When the mold surface provided on the core 10 includes a curved surface portion formed as a curved surface, the cooling channel 100 may also be formed in a curved shape to evenly cool the mold surface of the core 10. Therefore, the lengths of the plurality of cooling channels 100 may be different from each other. However, the disclosure is not limited thereto.

In addition, the cooling channels 100 may have substantially the same cross-sectional areas to cool the core 10 evenly. The cooling channels 100 may be regularly arranged. However, the disclosure is not limited thereto.

In this embodiment, the cooling channel 100 may be formed in both the first core 11 and the second core 12, but the disclosure is not limited thereto, and the cooling channel 100 may be formed only in one of the first core 11 and the second core 12.

The injection mold 1 may include an inlet 111 provided to allow the cooling fluid to be introduced into the injection mold 1 through the cooling channel 100 and an outlet 112 provided to discharge the cooling fluid introduced through the inlet 11 to the outside of the injection mold 1.

The core 10 includes a core inlet 111a allowing the cooling fluid to be introduced into the core 10 through the cooling channel 100 and a core outlet 112a allowing the cooling fluid introduced through the core inlet 111a to be discharged to the outside of the core 10.

The core inlet 111a may be disposed on the first end portion 13, and the core outlet 112a may be disposed on the second end portion 14. However, the disclosure is not limited thereto.

The cooling channel 100 may include a first cooling channel 110 configured to communicate with the core inlet 111a and the core outlet 112a. The first cooling channel 110 may be configured toward the horizontal direction. However, the disclosure is not limited thereto.

The first cooling channel 110 may be provided in a plurality of units thereof. The plurality of first cooling channels 110 may be formed along the horizontal direction communicating with the core inlet 111a and the core outlet 112a, and may be spaced apart from each other along a direction perpendicular to the horizontal direction.

The cooling fluid capable of cooling the core 10 is introduced through the core inlet 111a and flows along the first cooling channel 110 to cool the core 10, and then is discharged through the core outlet 112a, circulating the cooling channel 100.

The cooling channel 100 may include a second cooling channel 200 that is vertically formed inside the core 10 while crossing the first cooling channel 110.

The first cooling channel 110 passes through the core 10 and efficiently cool the core 10, but since the first cooling channel 110 is spaced apart from the cavity 20 by a certain distance, cooling the resin injected in the cavity 20 may be inefficient.

The second cooling channel 200 may be configured in the vertical direction toward the cavity 20 while crossing the first cooling channel 110. Accordingly, the cooling fluid flowing from the first cooling channel 110 to the second cooling channel 200 may efficiently cool the resin injected in the cavity 20.

Accordingly, the cooling fluid flowing through the first cooling channel 110 and the second cooling channel 200 may efficiently cool both the core 10 and the injection material injected in the cavity 20.

The second cooling channel 200 may be provided in a plurality of thereof. The plurality of second cooling channels 200 may be spaced apart from each other along the first cooling channel 110. The sizes of the plurality of second cooling channels 200 may vary depending on the shape of the injection object.

A plurality of the second cooling channels 200 may be disposed for a single first cooling channel 110. However, the disclosure is not limited thereto.

The injection mold 1 may include a baffle plate 120 configured to switch the flow of a cooling fluid flowing through the cooling channel 100. The baffle plate 120 may be fitted into the inside of the cooling channel 100 to partition the cooling channel 100. The baffle plate 120 may be fitted into the second cooling channel 200 to partition the second cooling channel 200.

During injection molding, the cooling fluid flowing through the first cooling channel 110 may be guided to the second cooling channel 200, and may circulate up and down by the baffle plate 120 inside the second cooling channel 200.

The baffle plate 120 may be manufactured by machining a stainless steel plate, a copper plate, or an aluminum plate. In consideration of the manufacturing process and price, the baffle plate 120 may be manufactured through plastic injection.

For example, the baffle plate 120 may include polycarbonate (PC) and glass fiber (GF) having excellent durability, heat resistance, and corrosion resistance, where GF refers to glass fiber in a resin state. However, the disclosure is not limited thereto.

The second cooling channel 200 may include a sub-cooling channel 210 communicating with the first cooling channel 110 and a main cooling channel 220 overlapping the sub-cooling channel 210. The area where the sub-cooling channel 210 and the main cooling channel 220 overlap may be variously provided according to the shape of the injection object.

The main cooling channel 200 may be disposed between two adjacent first cooling channels 110 among the plurality of first cooling channels 110 to be spaced apart from the two adjacent first cooling channels 110. Therefore, the main cooling channel 220 may be freely arranged without depending on the first cooling channel 110 constructed along the horizontal line.

The main cooling channel 220 and the sub-cooling channel 210 may have different heights from each other. However, the disclosure is not limited thereto.

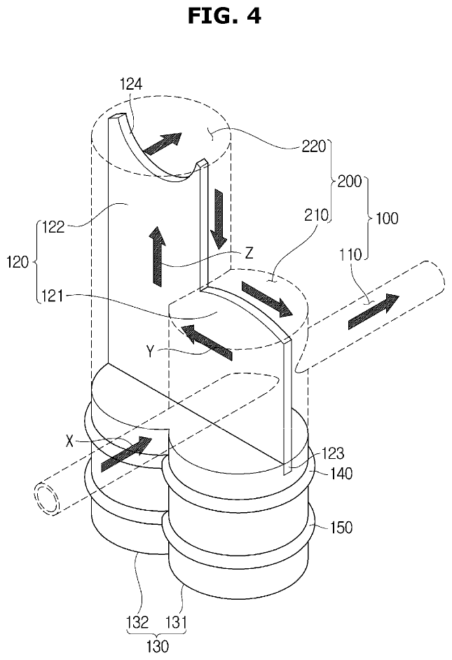

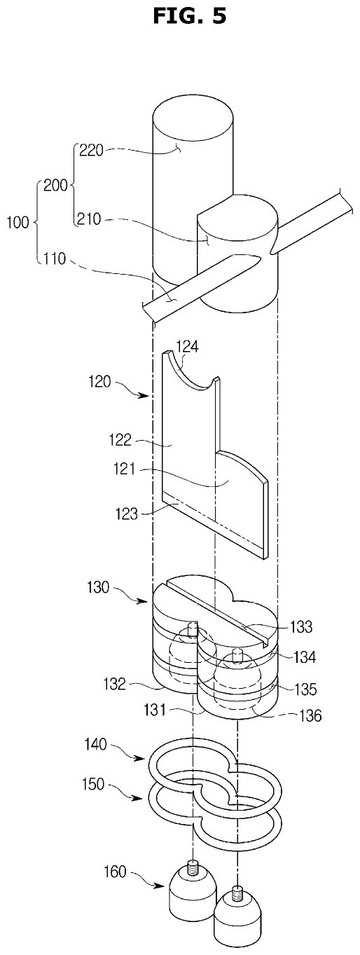

FIG. 4 is a view illustrating an injection mold according to the disclosure, which shows a flow of a cooling fluid flowing in a cooling channel. FIG. 5 is an exploded view illustrating an injection mold according to the disclosure, which shows disassembled parts of a cooling channel.

Referring to FIGS. 4 and 5, the baffle plate 120 includes a sub-baffle portion 121 guiding the cooling fluid flowing through the second cooling channel 200 and inserted into the sub-cooling channel 210 and a main baffle portion 122 inserted into the main cooling channel 220.

The sub-baffle portion 121 may correspond to the shape of the sub-cooling channel 210, and the main baffle portion 122 may correspond to the shape of the main cooling channel 220.

The sub-baffle portion 121 and the main baffle portion 122 may overlap each other. The area where the sub-baffle portion 121 and the main baffle portion 122 overlap may be variously provided according to the shape of the injection object.

The baffle plate 120 may block the flow of the cooling fluid flowing through the cooling channel 100. The baffle plate 120 may include a flow portion 124 provided to guide the flow of the cooling fluid flowing through the cooling channel 100.

The flow portion 124 may be provided at one end portion of the baffle plate 120. The flow portion 124 may be disposed adjacent to the cavity 20. However, the disclosure is not limited thereto. The size and shape of the flow portion 124 may be provided in various ways. The injection mold 1 may include a cap 130 inserted into the second cooling channel 200 and coupled to one end portion of the baffle plate 120 to prevent the cooling fluid flowing through the second cooling channel 200 from being discharged to the outside of the core 10. The baffle plate 120 may be firmly installed by the cap 130 without being separated from the cooling channel 100.

The cap 130 may include a cap groove 133 into which the baffle plate 120 is inserted. The cap groove 133 may be provided on an upper portion of the cap 130. The baffle plate 120 may include an insertion portion 123 that may be inserted into the cap groove 133.

The size and shape of the cap groove 133 may be configured to correspond to the size and shape of the insertion portion 123.

The cap 130 may include a sub-cap portion 131 corresponding to the shape of the sub-cooling channel 210 and a main cap portion 132 corresponding to the shape of the main cooling channel 220.

The sub cap portion 131 and the main cap portion 132 may overlap each other. The area where the sub cap portion 131 and the main cap portion 132 overlap may be variously provided according to the shape of the injection object.

The sub cap portion 131 may be coupled to the sub-baffle portion 121, and the main cap portion 132 may be coupled to the main baffle portion 122. The cross section of the cap 130 may have an approximately “8” shape. However, the disclosure is not limited thereto.

The injection mold 1 may include a cap ring 140 that seals between the second cooling channel 200 and the cap 130 and a press ring 150 that presses the cap 130.

The cap ring 140 seals between the second cooling channel 200 and the cap 130 to prevent the cooling fluid flowing through the cooling channel 100 from leaking out of the core 10.

The press ring 150 may strengthen the coupling between the cap 130 and the second cooling channel 200 by pressing the outside of the cap 130.

The cap 130 may include a cap ring groove 134 into which the cap ring 140 is inserted and a press ring groove 135 into which the press ring 150 is inserted. The cap ring groove 134 and the press ring groove 135 may include a shape corresponding to a cross section of the cap 130. However, the disclosure is not limited thereto.

The press ring groove 135 may be disposed below the cap ring groove 134. The cap ring groove 134 and the press ring groove 135 may be provided in various shapes and sizes corresponding to the cap ring 140 and the press ring 150, respectively.

The injection mold 1 may include a taper screw 160 that interacts with the press ring 150 so that the press ring 150 presses the cap 130. The cap 130 may include a screw groove 136 into which the taper screw 160 is inserted.

The screw groove 136 may be disposed on a lower portion of the cap 130. The screw groove 136 may be formed in each of the sub cap portion 131 and the main cap portion 132. The shape and size of the screw groove 136 may be variously provided according to the shape and size of the taper screw 160.

The cooling channel 100 is configured to direct the cooling fluid inside the cooling channel 100 in a first direction X flowing along the first cooling channel 110, in a second direction Z flowing along the second cooling channel 200, and in a third direction Y flowing between the sub-cooling channel 210 and the main cooling channel 220.

Here, the first direction X, the second direction Z, and the third direction Y are expressed as X, Y, and Z for the sake of convenience in description, but the first direction X, the second direction Z, or the third direction Y do not need to be perpendicular to each other.

In addition, the first direction X, the second direction Z, and the third direction Y may not refer to only one direction from one point to the other point, but may refer to one direction from one point to the other point and the other direction from the other point to one point that is opposite to the one direction.

The main cooling channel 220 may be arranged to be spaced apart from the first cooling channel 110 in the third direction Y, and the sub-cooling channel 210 and the main cooling channel 220 may have different lengths in the second direction Z. However, the disclosure is not limited thereto.

Hereinafter, the flow of the cooling fluid flowing through the cooling channel 100 according to the disclosure will be described in detail.

The cooling fluid flowing through the cooling channel 100 flows through the first cooling channel 110 along the first direction X, and is switched at the sub-cooling channel 210 by the sub-baffle portion 121, to flow along the third direction Y.

The cooling fluid flowing from the sub-cooling channel 210 to the main cooling channel 220 along the third direction Y is switched at the main cooling channel 220 by the main baffle portion 122 to flow along the second direction Z.

The cooling fluid flowing along the second direction Z in the main cooling channel 220 is guided by the flow portion 124 in the main cooling channel 220 to flow along the first direction X, and is then guided by the main baffle portion 122 again to thereby flow along the second direction Z.

The cooling fluid flowing through the main cooling channel 220 along the second direction Z is guided by the main baffle portion 122 to thereby flow from the main cooling channel 220 to the sub-cooling channel 210 along the third direction Y.

The cooling fluid flowing through the sub-cooling channel 210 along the third direction Y is guided by the sub-baffle portion 121 to flow from the sub-cooling channel 210 toward the first cooling channel 110 along the first direction Z.

Therefore, the cooling channel 100 according to the disclosure may be freely arranged according to the shape of the injection object so that the cooling fluid flowing through the cooling channel 100 has a three-dimensional flow, rather than a two-dimensional flow, which may uniformly cool the injection object.

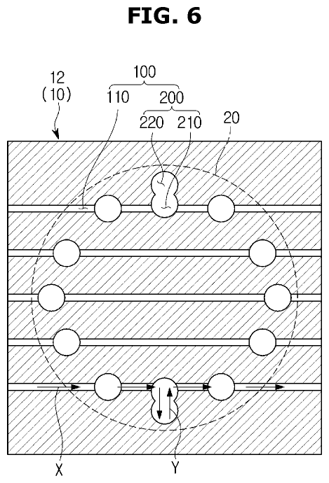

FIG. 6 is a cross-sectional view illustrating an injection mold according to the disclosure which is viewed along line B-B′ in FIG. 1. As illustrated in FIG. 6, the main cooling channel 220 may be disposed closer to the cavity 20 into which the resin forming the injection object is injected than the sub-cooling channel 210 is.

Although the cavity 20 shown in FIG. 6 is illustrated as having a circular shape, such as a cup, and including a receiving space at the center and a rim at the edge, such that an injection object having an approximately “⊏” shaped cross-section is formed, the disclosure is not limited thereto.

In general, the second cooling channel 200 formed as a vertical line adjacent to the cavity 20 needs to cross the first cooling channel 110 formed as a horizontal line so that the cooling channel 100 may be configured. Accordingly, the arrangement of the second cooling channels 200 may depend on the arrangement of the first cooling channels 110.

Since the cooling channel 100 is formed in the core 10 through a gun drill, when the separation distance between the plurality of first cooling channels 110 is too narrow, the core 10 may be deformed or broken by an external force forming the plurality of first cooling channels 110.

Therefore, the separation distance between the plurality of first cooling channels 110 may be limited, and the separation distance between the plurality of first cooling channels 110 may be preferably 50 mm to 100 mm.

Accordingly, it may be difficult to install the second cooling channel 200 depending on the first cooling channel 110 in an optimal position according to the structure of the injection object.

When the second cooling channel 200 may not be disposed in an optimal position for uniformly cooling the injection object, a temperature deviation inside the core 10 occurs, so that the cooling efficiency of the core 10 may be reduced, and productivity of the injection object may decrease.

In particular, in the case of an injection object having a receiving space in the center and a rim on the edge, such as a cup shape, a temperature deviation may be large at the rim of the edge.

The second cooling channel 200 according to the disclosure includes the main cooling channel 220 that may be disposed closer to the injection object than the sub-cooling channel 210 is, at a specific point where temperature deviation may occur, thereby allowing the injection object to be cooled uniformly.

The main cooling channel 220 may be provided in a plurality of units thereof that may overlap each other. The plurality of main cooling channels 220 may include a first main cooling channel extending from the sub-cooling channel 210 and a second main cooling channel extending from the main cooling channel 220. Therefore, the main cooling channel 220 may be variously arranged according to the shape of the injection object.

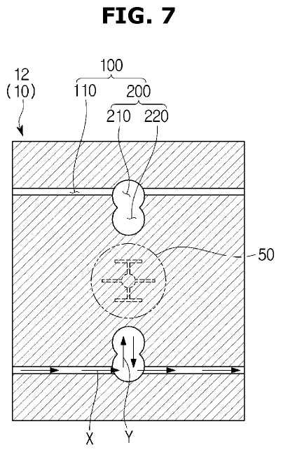

FIG. 7 is a view illustrating an injection mold according to the disclosure, in which a main cooling channel is disposed adjacent to a part of an injection object. As shown in FIG. 7, the main cooling channel 220 may be arranged closer to a part of an injection object disposed between two adjacent first cooling channels 110 among the plurality of first cooling channels 110 than the sub-cooling channel 210 is.

The injection object may include a rib 50, such as a boss, for coupling with other injection objects depending on the shape thereof The position of the rib 50 formed in the injection object may be provided between two adjacent first cooling channels 110 among the plurality of first cooling channels 110.

Therefore, there is a case in which the first cooling channel 110 may not be configured adjacent to the rib 50, and in this case, the rib 50 may form a hot spot that has a higher temperature compared to the temperature of other parts of the injection object.

The main cooling channel 220 is disposed between the two adjacent first cooling channels 110 among the plurality of first cooling channels 110 without depending on the first cooling channel 110, thereby efficiently cooling the hot spot of the injection object, such as the rib 50.

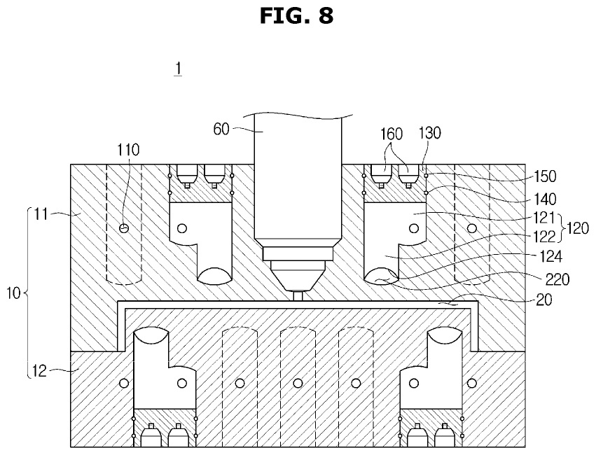

FIG. 8 is a view illustrating an injection mold according to the disclosure, which shows a main cooling channel disposed adjacent to an injection port.

Referring to FIG. 8, the injection mold 1 may include an injection device (not shown) for injecting a molten resin into the cavity 20, and the injection device (not shown) may include an injection port 60 connected to the cavity 20.

Although the injection port 60 is illustrated as being formed to pass through the upper portion of the first core 11 to be connected to the cavity 20 in FIG. 8, the disclosure is not limited thereto, and the injection port 60 may be variously arranged as long as it can be connected to the cavity 20.

The inside of the injection port 60 is filled with a high temperature resin for forming an injection object, and thus a portion of the core 10 through which the injection port 60 passes may have a relatively high temperature compared to other portions of the core 10.

The main cooling channel 220 may be disposed closer to the injection port 60 for injecting a resin for forming an injection object into the cavity 20 than the sub-cooling channel 210 that depends on the first cooling channel 110.

In some cases, the first cooling channel 110 may not be disposed adjacent to the injection port 60 due to the size and arrangement of the injection port 60.

Therefore, when the first cooling channel 110 may not be configured adjacent to the injection port 60, a portion of the core 10 through which the injection port 60 passes may form a hot spot of high temperature compared to the temperature of other portions of the core 10.

The main cooling channel 220 is disposed between two adjacent first cooling channels 110 with the injection port 60 interposed therebetween among the plurality of first cooling channels 110, while being disposed closer to the injection port 60 than the sub-cooling channel 210 is.

The main cooling channel 220, unlike the sub-cooling channel 210, may be disposed adjacent to the injection port 60 without depending on the first cooling channel 110, thereby efficiently cooling the hot spot, such as the portion of the core 10 through which the injection port 60 passes.

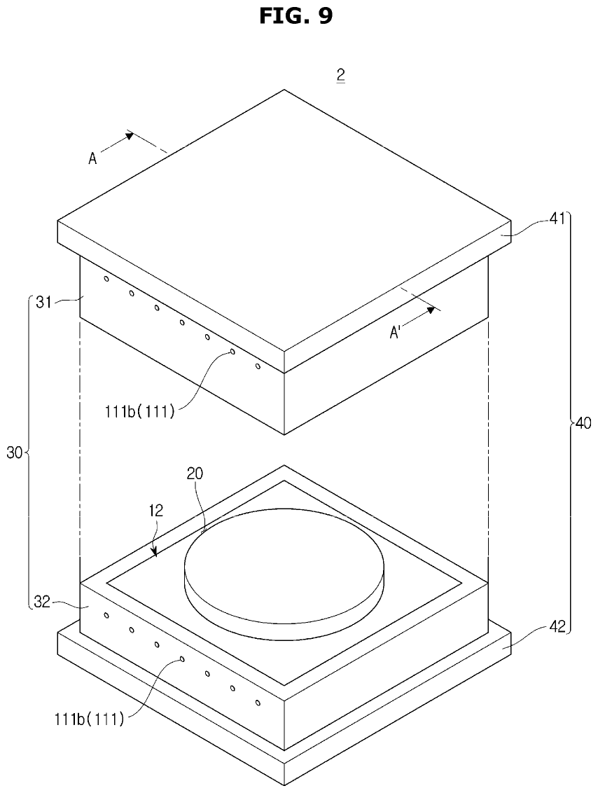

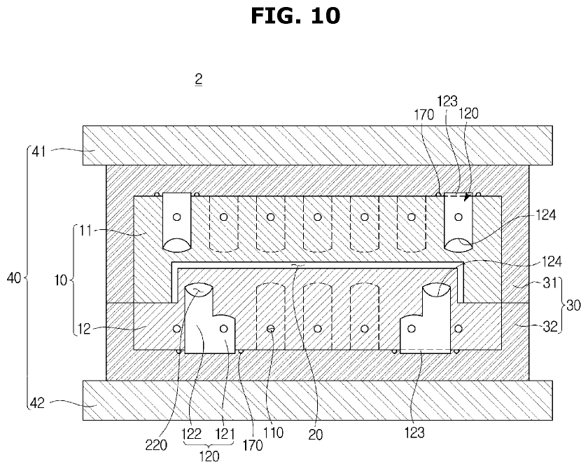

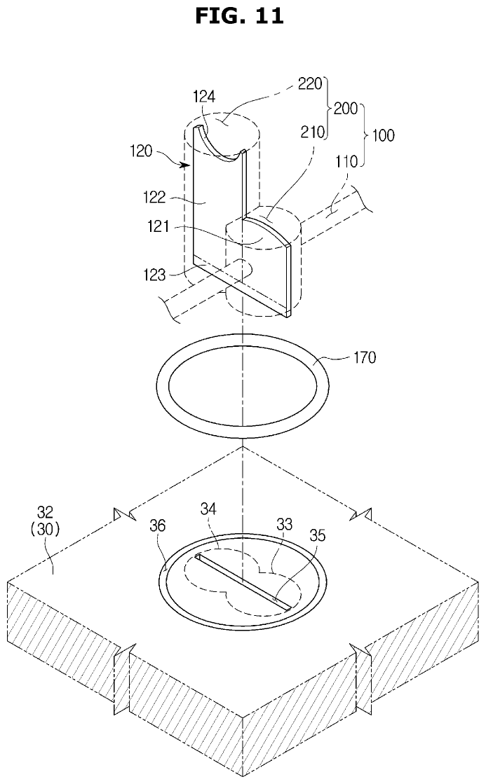

FIG. 9 is a perspective view illustrating an injection mold according to another embodiment of the disclosure. FIG. 10 is a cross-sectional view illustrating an injection mold according to another embodiment of the disclosure, which is viewed along line A-A′ in FIG. 9. FIG. 11 is an exploded view illustrating an injection mold according to another embodiment of the disclosure, in which a core including a cooling channel and a template are disassembled.

Referring to FIGS. 9 to 11, an injection mold 2 according to another embodiment of the disclosure may include a mold plate 30 provided to accommodate a core 10 and an installation plate 40 on which the mold plate 30 is installed.

The mold plate 30 may include a first mold plate 31 and a second mold plate 32 separably coupled to the first template 31. The installation plate 40 may include a first installation plate 41 and a second installation plate 42 disposed to face the first installation plate 41.

The first mold plate 31 may accommodate the first core 11, and the second mold plate 32 may accommodate the second core 12. The first installation plate 41 may be coupled to the first mold plate 31, and the second installation plate 42 may be coupled to the second mold plate 32.

The installation plate 40 may be connected to a transfer device (not shown) provided so that the mold plate 30 accommodating the core 10 may move.

In the embodiment, the second installation plate 42 may be fixedly installed on the ground, and the first installation plate 41 may be installed to be movable up and down on the second installation plate 42.

Therefore, when the first installation plate 41 moves downward and the first mold plate 31 is coupled to the second mold plate 32, the cavity 20 is formed by the first core 11 and the second core 12.

When the first installation plate 41 moves upward and the first mold plate 31 is separated from the second mold plate 32, the injection object manufactured in the cavity 20 may be taken out of the injection mold 2.

In the embodiment, the first installation plate 41 and the second installation plate 42 may be arranged one above the other, the second installation plate 42 may be fixed, and the first installation plate 41 may move up and down, but this is for illustrative purpose only, and the first installation plate 41 and the second installation plate 42 may be arranged side by side on the left and right side.

In addition, the second installation plate 42 may be movably provided instead of the first installation plate 41 or both the first installation plate 41 and the second installation plate 42 may be movably provided.

The mold plate 30 includes a mold plate inlet 111b that allows a cooling fluid flowing through the core 10 and the cooling channel 100 to be introduced into the mold plate 30 and a mold plate outlet 112b allowing the cooling fluid introduced through the mold plate inlet 111b to be discharged to the outside of the injection mold 2.

The mold plate inlet 111b may communicate with the core inlet 111a, and the mold plate outlet 112b may communicate with the core outlet 112a.

The mold plate 30 may prevent the cooling fluid flowing through the second cooling channel 200 from being discharged to the outside of the core 10. The mold plate 30 may include a sub-mold plate portion 33 that blocks the sub-cooling channel 210 and a main-mold plate portion 34 that blocks the main cooling channel 220.

The mold plate 30 may include a mold plate groove 35 into which the insertion portion 123 of the baffle plate 120 is inserted. The sub-mold plate portion 33 may be coupled to the insertion portion 123, which corresponds to one end portion of the sub-baffle portion 121, and the main mold plate portion 34 may be coupled to the insertion portion 123, which corresponds to one end portion of the main baffle portion 122.

The injection mold 2 may include an O-ring 170 that seals between the core 10 and the mold plate 30. The O-ring 170 may have a circular shape. However, the disclosure is not limited thereto.

The mold plate 30 may include an O-ring groove 36 into which the O-ring 170 is inserted. The shape and size of the O-ring groove 36 may be variously provided corresponding to the shape and size of the O-ring 170.

Hereinafter, a method of manufacturing the injection mold 1 according to the disclosure will be described in detail.

First, the first cooling channel 110 may be formed to pass through the inside of the core 100 along the horizontal direction such that the first cooling channel 110 allows a cooling fluid capable of cooling the core 10 to flow therethrough and has the first end portion 13 of the core 10 and the second end portion 14 of the core 10 opposite to the first end portion 13 communicate with each other.

The first cooling channel 110 may be provided in a plurality of units thereof, and the plurality of first cooling channels 110 may be formed to be spaced apart from each other at a predetermined distance to prevent deformation and breakage of the core 10.

Next, the sub-cooling channel 210 may be formed to pass through the inside of the core 10 along the vertical direction while crossing the first cooling channel 110 and communicating with the third end portion 15 of the core 10.

Since the arrangement of the sub-cooling channel 210 needs to be dependent on the first cooling channel 110, the sub-cooling channel 210 communicates with the third end portion 15 of the core 10 for efficient cooling according to the shape of the injection object, and the main cooling channel 220 may be formed to pass through the inside of the core 10 along the vertical direction while overlapping the sub-cooling channel 210.

Even though the sub-cooling channel 210 and the main cooling channel 220 are formed to pass through the core 10 while overlapping each other, the lengths of the sub-cooling channel 210 and the main cooling channel 220 are relatively smaller than that of the first cooling channel 110, and thus not cause deformation and breakage of the core 10.

Then, in order to switch the flow of the cooling fluid inside the sub-cooling channel 210 and the main cooling channel 220, the baffle plate 120 including the sub-baffle portion 121 corresponding to the shape of the sub-cooling channel 210 and the main baffle portion 122 corresponding to the shape of the main cooling channel 220 is inserted into the sub-cooling channel 210 and the main cooling channel 220.

Finally, in order to prevent the cooling fluid flowing inside the second cooling channel 200 from leaking to the outside of the core 10 and fix the baffle plate 120, the cap 130 may be inserted into the second cooling channel 200 or the core 10 may be received in the mold plate 30.

Although specific embodiments of the disclosure have been described by way of example of the inventive concept of the disclosure, there is no intent to limit the scope of the rights of the disclosure to the particular forms disclosed.

The disclosure is to cover all modifications, equivalents, and alternatives of various embodiments made by those skilled in the art without departing from the scope and spirit of the disclosure as disclosed in the accompanying claims

1. An injection mold comprising:
a core comprising a first core configured to form a cavity corresponding to a shape of an injection object and a second core separably coupled to the first core; and
a cooling channel communicating with an outside of the core and comprising a first cooling channel horizontally provided in the core to guide flow of a cooling fluid for cooling the core and a second cooling channel vertically provided in the core while crossing the first cooling channel,
wherein the second cooling channel comprises:
a sub-cooling channel communicating with the first cooling channel; and
a main cooling channel overlapping the sub-cooling channel.

2. The injection mold of claim 1, wherein the first cooling channel is provided in a plurality of units thereof to be spaced apart from each other,
the main cooling channel is disposed to be spaced apart from two adjacent first cooling channels of the plurality of first cooling channels.

3. The injection mold of claim 1, wherein the cooling channel is configured to direct the cooling fluid in the cooling channel in a first direction flowing along the first cooling channel, a second direction flowing along the second cooling channel, and a third direction flowing between the sub-cooling channel and the main cooling channel.

4. The injection mold of claim 3, wherein the main cooling channel is spaced apart from the first cooling channel in the third direction.

5. The injection mold of claim 3, wherein the sub-cooling channel and the main cooling channel have different lengths in the second direction.

6. The injection mold of claim 1, further comprising a baffle plate configured to guide the cooling fluid flowing through the second cooling channel, and comprising a sub-baffle portion inserted into the sub-cooling channel and a main baffle portion inserted into the main cooling channel.

7. The injection mold of claim 6, further comprising a cap inserted into the second cooling channel and coupled to one end portion of the baffle plate to prevent the cooling fluid flowing through the second cooling channel from being discharged out of the core,
wherein the cap comprises a sub-cap portion corresponding to a shape of the sub-cooling channel and a main cap portion corresponding to a shape of the main-cooling channel.

8. The injection mold of claim 7, wherein the cap comprises a cap groove into which the baffle plate is inserted and a cap ring groove into which a cap ring for sealing between the second cooling channel and the cap is inserted.

9. The injection mold of claim 8, wherein the cap comprises: a press ring groove arranged below the cap ring groove and into which a press ring for pressing the cap is inserted; and a screw groove into which a taper screw interacting with the press ring to press the cap is inserted and provided in a lower portion of the cap.

10. The injection mold of claim 2, wherein the main cooling channel is arranged closer to a portion of an injection object disposed between the two adjacent first cooling channels of the plurality of first cooling channels than the sub-cooling channel is.

11. The injection mold of claim 1, wherein the main cooling channel is arranged closer to an injection port for injecting a resin for forming the injection object into the cavity than the sub-cooling channel is.

12. The injection mold of claim 6, further comprising a mold plate accommodating the core to prevent the cooling fluid flowing through the second cooling channel from being discharged out of the core,
wherein the mold plate comprises a sub-mold plate portion for blocking the sub-cooling channel and a main mold plate portion for blocking the main cooling channel.

13. The injection mold of claim 12, wherein the mold plate comprises a mold plate groove into which the baffle plate is inserted and an O-ring groove into which an O-ring for sealing between the core and the mold plate is inserted.

14. The injection mold of claim 3, wherein the cooling channel is configured such that the cooling fluid introduced through an inlet provided in the core flows through the first cooling channel along the first direction, is switched along the third direction from flowing through the sub-cooling channel to flowing through the main cooling channel, and is switched along the second direction to flowing through the second cooling channel.

15. A method of manufacturing an injection mold, the method comprising:
forming a first cooling channel horizontally to pass through a core such that the first cooling channel allows a cooling fluid for cooling the core to flow therethough and has a first end portion of the core and a second end portion opposite to the first end portion communicate with each other;
forming a sub-cooling channel vertically to pass through the core while crossing the first cooling channel and communicating with a third end portion of the core; and
forming a main-cooling channel vertically to pass through the core while communicating with the third end portion of the core and overlapping the sub-cooing channel.
